(19) United States
(12) Patent Application Publication
(10) Pub. No.: US 2026/0056691 A1
(43) Pub. Date: Feb. 26, 2026

(54) IMAGE FORMING APPARATUS AND CONTROL METHOD OF IMAGE FORMING APPARATUS

(71) Applicant: Sharp Kabushiki Kaisha, Osaka (JP)

(72) Inventor: AKIRA OGAWA, Osaka (JP)

(21) Appl. No.: 19/304,866

(22) Filed: Aug. 20, 2025

(30) Foreign Application Priority Data
Aug. 21, 2024 (JP) 2024-140034

(51) Int. Cl. G06F 3/12; H04N 1/00

(52) U.S. Cl. CPC G06F 3/1257; G06F 3/1205; G06F 3/1255; G06F 3/1258; H04N 1/00408; H04N 1/00384; H04N 2201/0094

(57) ABSTRACT

An image forming apparatus, includes: a storage that stores one or more setting values corresponding to one or more setting items; one or more controllers that execute control in accordance with the one or more setting values; a display; and an acquirer, wherein the one or more controllers store one or more first setting values corresponding to one or more first setting items in the storage, acquire one or more second setting values using the acquirer, extract, from the one or more first setting items, one or more setting items in which the one or more first setting values different from the one or more second setting values are stored, and display an update screen related to whether the one or more first setting values corresponding to one or more extracted setting items are updatable with the one or more second setting values on the display.

### CROSS-REFERENCE TO RELATED APPLICATION

The present application claims priority from Japanese Application JP2024-140034, the content to which is hereby incorporated by reference into this application.

### BACKGROUND OF THE INVENTION

### 1. Field of the Invention

The present disclosure relates to an image forming apparatus and the like.

### 2. Description of the Related Art

In recent years, image forming apparatuses have been multi-functionalized. Accordingly, the number of setting items for which setting values need to be set in order to operate the image forming apparatus has been increasing. In the related art, a method for reducing the burden of setting work for setting values is known.

### SUMMARY OF THE INVENTION

An object of the present disclosure is to provide, for example, an image forming apparatus that can appropriately set setting values.

The present disclosure provides an image forming apparatus including a storage that stores one or more setting values corresponding to one or more setting items, one or more controllers that execute control in accordance with the one or more setting values, a display, and an acquirer, in which the one or more controllers store one or more first setting values corresponding to one or more first setting items in the storage, acquire one or more second setting values using the acquirer, extract, from the one or more first setting items, one or more setting items in which the one or more first setting values different from the one or more second setting values are stored, and display an update screen related to whether the one or more first setting values corresponding to one or more extracted setting items are updatable with the one or more second setting values on the display.

In addition, the present disclosure also provides a control method of an image forming apparatus, the method including storing one or more first setting values corresponding to one or more first setting items, acquiring one or more second setting values, extracting, from the one or more first setting items, one or more setting items in which the one or more first setting values different from the one or more second setting values are stored, and displaying an update screen related to whether the one or more first setting values corresponding to one or more extracted setting items are updatable with the second setting value.

According to the present disclosure, for example, it is possible to provide an image forming apparatus that can appropriately set setting values.

### BRIEF DESCRIPTION OF THE DRAWINGS

FIG. 1 is an external perspective view of an image forming apparatus according to a first embodiment of the present disclosure.

FIG. 2 is a functional block diagram of the image forming apparatus according to the first embodiment of the present disclosure.

FIG. 3 is a flowchart illustrating an operation of import processing of the image forming apparatus according to the first embodiment of the present disclosure.

FIG. 4 is an example of an initial setup setting table.

FIG. 5 is an example of import data.

FIG. 6 is an example of a confirmation screen displayed on the image forming apparatus according to the first embodiment of the present disclosure.

FIG. 7 is a flowchart illustrating an operation of an image forming apparatus according to a second embodiment of the present disclosure.

FIG. 8 is an example of a selection screen displayed on the image forming apparatus according to the second embodiment of the present disclosure.

FIG. 9 is a flowchart illustrating an operation of an image forming apparatus according to a third embodiment of the present disclosure.

FIG. 10 is an example of a notification screen displayed on the image forming apparatus according to the third embodiment of the present disclosure.

### DETAILED DESCRIPTION OF THE INVENTION

In general, an initial setup wizard is one of methods for reducing the load of the setting work of the setting value. The initial setup wizard may be provided in response to legal revisions aimed at enhancing cybersecurity measures for Internet of Things (IoT) products. In this case, the initial setup wizard is intended to allow the user to smoothly perform security-related settings of the image forming apparatus before starting use of the image forming apparatus.

In addition, one such method is import processing. The import processing is processing for collectively setting values of a plurality of setting items based on import data acquired from outside.

However, when the import processing is executed after the initial setup wizard is executed in the image forming apparatus, the setting value set in the initial setup wizard may be changed by the import processing before the user notices the change. In general, since the setting values set in the initial setup wizard include setting values related to security protection, it is not recommended to change the settings during use except for special reasons such as a change in the setup environment or the operation method.

An example of an image forming apparatus that solves one of such problems will be described in the following embodiment.

### 1. First Embodiment

### [1.1 Configuration]

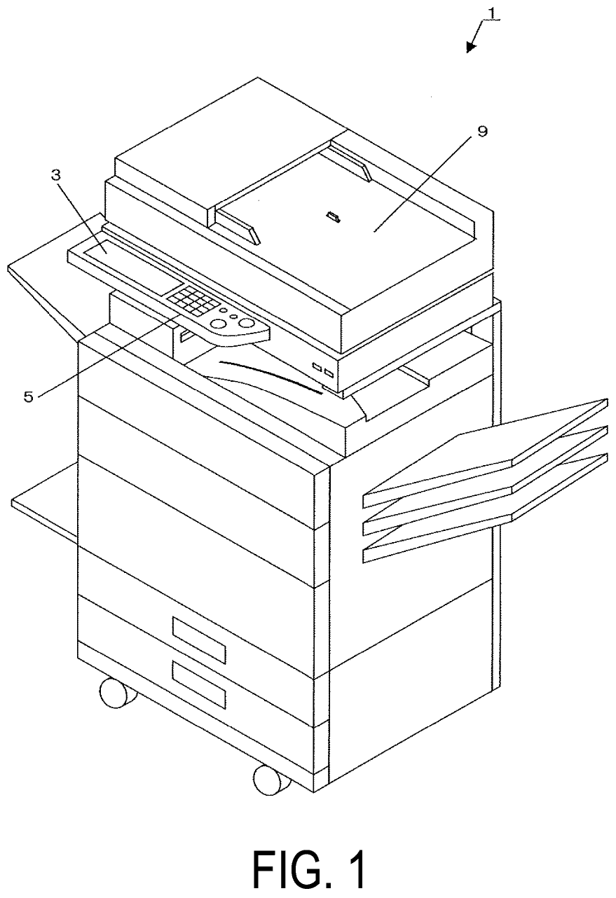

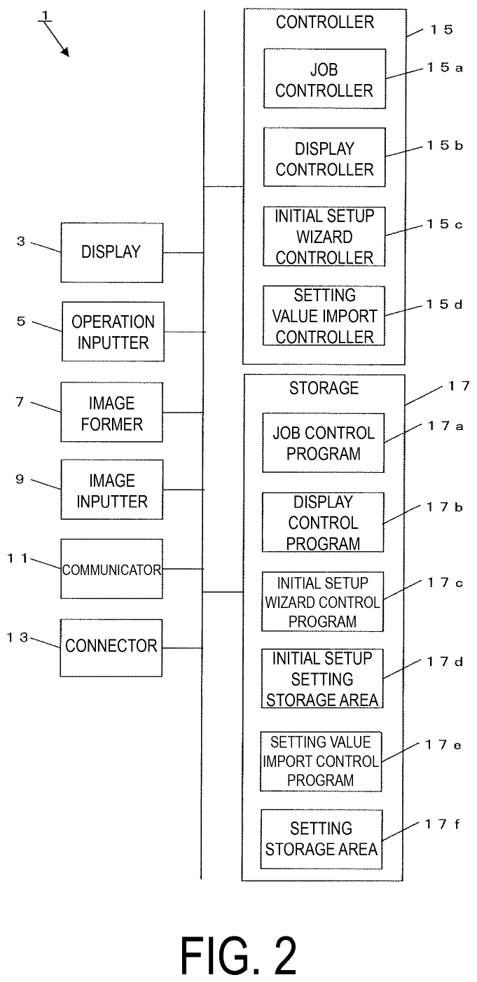

FIG. 1 is an external perspective view of an image forming apparatus 1 according to a first embodiment of the present disclosure. FIG. 2 is a functional block diagram of the image forming apparatus 1 according to the first embodiment of the present disclosure. The image forming apparatus 1 is a multi-function printer/peripheral (MFP) or a multifunction device, and typically has a copy function, an image scanner function, a facsimile function, and a printer function. The image forming apparatus 1 may further have other functions, such as an email sending and receiving function, a file server function, and the like. The image forming apparatus 1 includes a display 3, an operation inputter 5, an image former 7, an image inputter 9, a communicator 11, a connector 13, a controller 15, and a storage 17.

The display 3 displays images and characters. For example, the display includes a liquid crystal display (LCD) or an organic Electro-Luminescence (EL) panel. The display 3 may be a single display device, or may further include a display device connected to the outside.

The operation inputter 5 receives an operation input from a user. For example, the operation inputter 5 is composed of hardware keys or software keys. Further, the operation inputter 5 includes task keys for instructing to execute tasks such as fax transmission and image reading, and operation keys such as a cancel key for instructing to cancel an operation, for example. The operation inputter 5 can be configured as a touch panel that can receive input via the display 3. When the operation inputter 5 is configured as the touch panel, the operation inputter can detect user's touch, tap, swipe, or the like with respect to an object displayed via the display 3, and can acquire a coordinate position, pressure-sensitive information, or the like of touch panel information. In this case, an input scheme for the touch panel can be a typical input scheme such as a resistive film scheme, an infrared scheme, an electromagnetic induction scheme, or a capacitive scheme.

The image inputter 9 reads out an image (document) and outputs the image as image data.

The image inputter 9 includes a typical scanner (image input device). Further, the image inputter 9 may input image data from an external storage medium such as a USB memory, or may receive image data via a network.

The image former 7 forms (prints) an image on a medium such as copy paper based on the image data. A printing scheme for the image former 7 is freely selected, and may be, for example, any of an inkjet printer, a laser printer, a thermal transfer printer, and the like. The image former 7 may be a monochrome printer or a color printer. The image former 7 may include a paper feed mechanism that supplies the medium, a transport mechanism that transports the medium, a sorter mechanism that sorts the medium after an image is formed, and the like.

The communicator 11 connects to a network. For example, the communicator includes an interface that can be connected to a wired local area network (LAN), a wireless LAN, or a long term evolution (LTE) network. The communicator 11 is connected to a network for connection to another device or an external network. In addition, the communicator 11 may be an interface for short-distance wireless communication such as near field communication (NFC) or Bluetooth (trade name).

The connector 13 connects the image forming apparatus 1 to another device. For example, the connector 13 is a USB interface to which a USB memory or the like is connected. Further, the connector 13 may be an interface such as HDMI (trade name), in addition to the USB interface.

The controller 15 controls the entirety of the image forming apparatus 1. The controller 15 includes one or more control devices or control circuits, and includes, for example, a central processing unit (CPU), which is a processor that executes various arithmetic processes, a system on a chip (SoC), and the like.

In addition, the controller 15 can realize each function by reading programs stored in the storage 17 and executing processing.

In particular, the controller 15 functions as a job controller 15a by executing a job control program 17a stored in the storage 17, a display controller 15b by executing a display control program 17b, an initial setup wizard controller 15c by executing an initial setup wizard control program 17c, and a setting value import controller 15d by executing a setting value import control program 17e. Hereinafter, each functional unit will be described in the storage 17.

The term “initial setup” here refers to an operation performed when setting up the image forming apparatus 1 is in an initialized state. For example, work performed on the image forming apparatus 1 at the time of initial startup after introduction of the image forming apparatus 1 or at the time of initial startup after resetting the settings of the image forming apparatus 1 (initial startup after initialization) is referred to as initial setup.

In addition, “wizard processing” refers to processing in which the image forming apparatus 1 stores setting values input by a user using one or more setting screens in a storage 17. The setting screen is a screen for receiving input of one or more setting values corresponding to one or more setting items from a user, and the one or more setting values input by the user via the setting screen are stored, in association with the one or more setting items, in a setting storage area 17f of the storage 17.

In addition, “initial setup wizard processing” refers to wizard processing executed at the time of initial setup of the image forming apparatus 1. In the image forming apparatus 1, at the time of initial setup (initial startup), initial setting values (default setting values) are stored as setting values corresponding to one or more setting items. By executing initial setup wizard processing at the time of initial setup (initial startup) of the image forming apparatus 1, a user can select whether to use setting values of the initial setting without change or to change them. In the present disclosure, setting values set by a user for one or more setting items in the initial setup wizard processing are referred to as “program setting values (first setting values)”.

The communicator 11 or the connector 13 is also referred to as an acquirer. In a case where the communicator 11 is the acquirer, the communicator 11 receives import data from another information processing apparatus connected via a network.

In a case where the connector 13 is the acquirer, the connector 13 reads import data stored in an external storage device such as a USB memory connected to the connector 13. The import data includes a setting value associated with a setting item to be updated in the import processing. The import processing here is processing of acquiring data from the outside and storing the data in the setting storage area 17f, for example. In addition, setting values included in import data are referred to as import setting values (second setting values)”. The import data may be in a predetermined format readable by the image forming apparatus 1, such as a comma separated values (CSV) format, an Extensible Markup Language (XML) format, or a JavaScript Object Notation (JSON) format.

The storage 17 stores various programs and various types of data necessary for the operation of the image forming apparatus 1. The storage 17 includes one or more recording devices capable of temporary storage, such as a dynamic random access memory (DRAM) or one or more non-temporary recording devices, such as a solid state drive (SSD) made of a semiconductor memory or a hard disk drive (HDD) made of a magnetic disk. Further, for convenience of explanation, the storage 17 is configured as one unit, but the storage 17 may be configured as separate devices for each purpose, such as an area used for execution of programs (main storage area), an area that stores programs or data (auxiliary storage area), and an area used for cashing.

The storage 17 stores the job control program 17a, the display control program 17b, the initial setup wizard control program 17c, and the setting value import control program 17e. In addition, the storage 17 includes the initial setup setting storage area 17d and the setting storage area 17f.

In a case where the controller 15 executes the job control program 17a, the controller 15 functions as the job controller 15a. The job controller 15a controls each unit of the image forming apparatus 1 to execute a job. For example, when executing a copy job or a print job, the job controller 15a reads out setting values stored in a setting storage area 17f and executes the job. In addition, the job controller 15a may store setting values related to the executed job as a job setting history in the storage 17.

When the controller 15 executes the display control program 17b, the controller 15 functions as the display controller 15b. The display controller 15b controls the display on the display 3, and particularly displays an update screen. The update screen is a screen related to whether to update a setting value corresponding to a first extraction setting item, which is a setting item corresponding to both a first setting item corresponding to a program setting value that is a first setting value and a second setting item corresponding to an import setting value that is a second setting value. The update screen includes, for example, a confirmation screen, a selection screen, and a notification screen, which will be described later.

The initial setup wizard control program 17c is a program for controlling the initial setup wizard. When the controller 15 executes the initial setup wizard control program 17c, the controller 15 functions as an initial setup wizard controller 15c. The initial setup wizard controller 15c displays a wizard screen for setting a setting value corresponding to one or more setting items in an interactive manner on the display 3. In addition, the initial setup wizard controller 15c sets a setting value corresponding to one or more setting items in accordance with an input received from the user via the operation inputter 5 while the wizard screen is displayed. When the setting value is set for each of one or more setting items, the setting value is stored in the setting storage area 17f as a user setting value in association with the setting item, and is stored in the initial setup setting storage area 17d as a program setting value in association with the setting item. Here, the program setting value is a setting value set for one or more setting items at the time of initial setup of the image forming apparatus 1.

The setting value import control program 17e is an execution program of the import processing, and when the setting value import control program 17e is executed, the controller 15 operates as a setting value import controller 15d. The initial setup setting storage area 17d stores an initial setup setting table. The initial setup setting table is a table that stores, in association with setting items, a setting value (hereinafter also referred to as a default setting value) stored in the setting storage area 17f immediately before the setting value stored in the setting storage area 17f is updated by the initial setup wizard, and a setting value (hereinafter also referred to as a program setting value) stored in the setting storage area 17f immediately after the setting value stored in the setting storage area 17f is updated by the initial setup wizard. The setting storage area 17f is an area for storing setting values of various setting items of the image forming apparatus 1. The setting value stored in the setting storage area 17f is also referred to as a user setting value. The job controller 15a executes a job based on the user setting value when executing the job.

### [1.2 Operation]

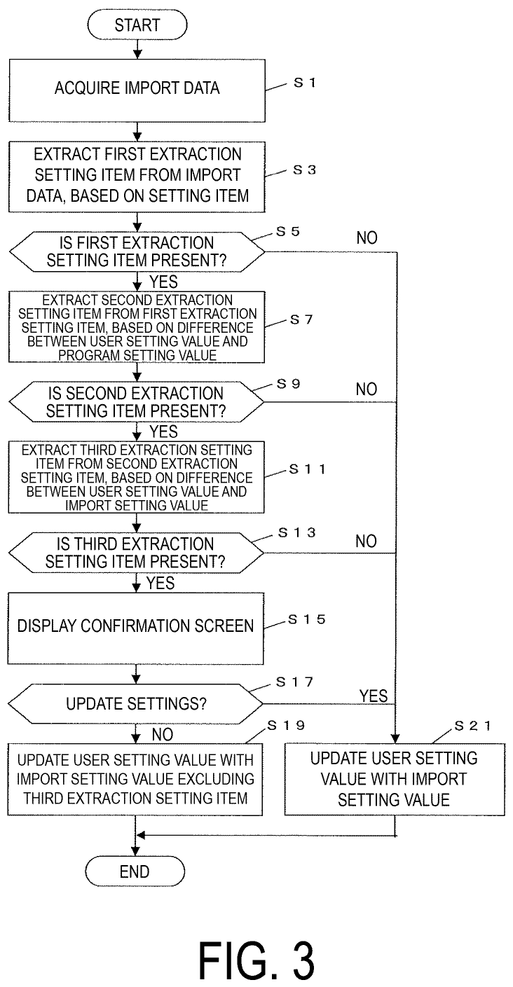

FIG. 3 is a flowchart illustrating an operation of import processing of the image forming apparatus 1 according to the first embodiment of the present disclosure. Here, the controller 15 operates as the setting value import controller 15d in accordance with the setting value import control program 17e read from the storage 17.

The setting value import controller 15d reads import data from the outside via the communicator 11 or the connector 13 (step S1). Next, the setting value import controller 15d extracts setting items existing in the initial setup setting table from the setting items of the import setting values included in the import data based on the initial setup setting table stored in the initial setup setting storage area 17d as first extraction setting items (step S3).

In a case where the number of setting items included in the first extraction setting items is one or more (step S5, YES), the processing proceeds to step S7. In a case where the number of setting items included in the first extraction setting items is zero (step S5, NO), the processing proceeds to step S21.

In step S7, the setting value import controller 15d compares, for each of the setting items included in the first extraction setting items, the current setting value (user setting value) corresponding to the setting item with the setting value (program setting value) set for the same setting item in the initial setup wizard. The setting value import controller 15d extracts a setting item in which the user setting value and the program setting value match (a setting item in which the setting value set in the initial setup wizard is set as the user setting value) as a second extraction setting item. In a case where the number of setting items included in the second extraction setting items is one or more (step S9, YES), the processing proceeds to step S11. When the number of setting items included in the second extraction setting items is zero (step S9, NO), the processing proceeds to step S21.

In step S11, the setting value import controller 15d compares, for each of the setting items included in the second extraction setting items, the user setting value corresponding to the setting item with the setting value (import setting value) set for the same setting item in the import data. The setting value import controller 15d extracts a setting item in which the user setting value and the import setting value do not match (a setting item in which a setting value different from the setting value set in the initial setup wizard is set as the import setting value) as a third extraction setting item. In a case where the number of setting items included in the third extraction setting items is one or more (step S13, YES), the processing proceeds to step S15. In a case where the number of setting items included in the third extraction setting items is zero (step S13, NO), the processing proceeds to step S21.

In step S15, the display controller 15b displays a confirmation screen on the display 3. The confirmation screen is a type of update screen, and is a screen for inquiring whether to execute the batch update of the setting values corresponding to the first extraction setting items. For example, the confirmation screen may be a screen for inquiring whether to execute the batch update of the setting values corresponding to the third extraction setting items.

When the confirmation screen is displayed on the display 3, in a case where an operation not to update the setting is received via the operation inputter 5 (step S17, NO), the setting value import controller 15d excludes the import setting value corresponding to the third extraction setting item from the import data, and updates the user setting value of the setting storage area 17f corresponding to the import setting value via the setting item using the remaining import setting value (step S19).

On the other hand, when the confirmation screen is displayed on the display 3, in a case where an operation to update the setting is received via the operation inputter 5 (step S17, YES), the setting value import controller 15d proceeds to step S21.

In step S21, the setting value import controller 15d updates the user setting value of the setting storage area 17f corresponding to the import setting value via the setting item using all the import setting values included in the import data.

### 1.3 Operation Example

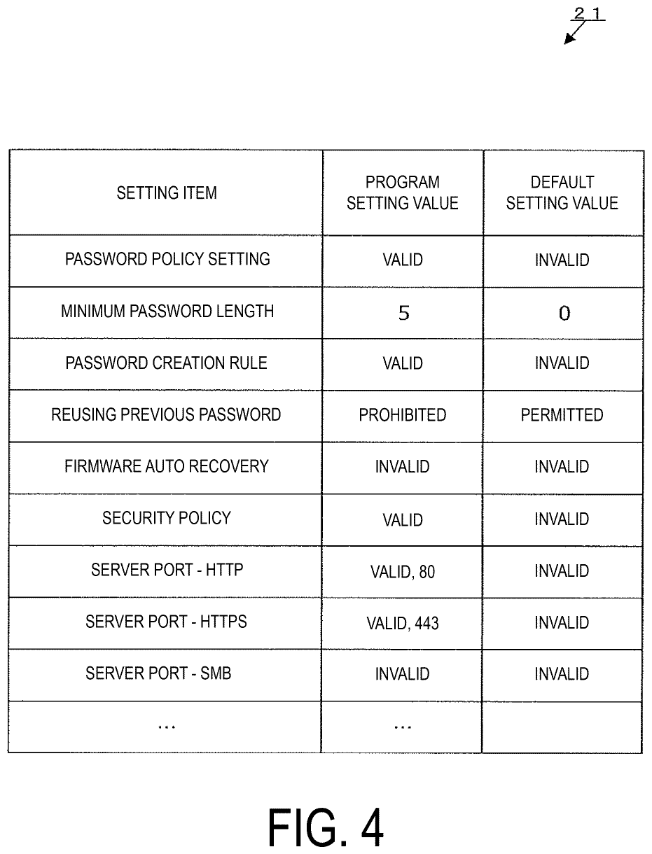

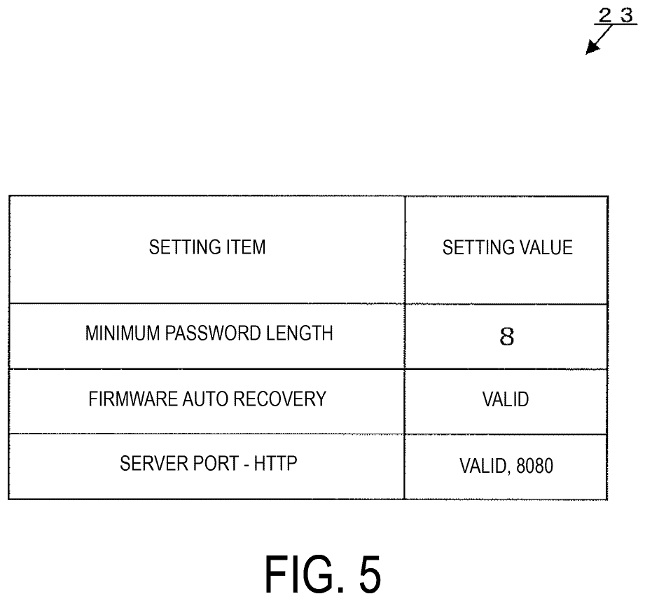

It is assumed that, as a result of the controller 15 executing the initial setup wizard control program 17c (initial setup wizard), the initial setup wizard controller 15c stores an initial setup setting table 21 of FIG. 4, which will be described later, in the initial setup setting storage area 17d. In addition, it is also assumed that the controller 15 has acquired import data 23 in FIG. 5, which will be described later, via the communicator 11 or the connector 13. An operation of the image forming apparatus 1 at this time will be described. In this operation example, it is assumed that the user setting value is not changed after the execution of the initial setup wizard.

The initial setup setting table 21 in FIG. 4 is an example of the initial setup setting table. The initial setup setting table 21 stores setting items to be updated from default setting values in the initial setup wizard, setting values (program setting values) set for the setting items to be updated by execution of the initial setup wizard, and setting values (default setting values) set for the setting items to be updated before being updated by execution of the initial setup wizard. For example, the top record in the initial setup setting table 21 indicates that the program setting value “valid” is set to the setting item “password policy setting” by the execution of the initial setup wizard, and the default setting value “invalid” is set before the execution of the initial setup wizard.

The import data 23 in FIG. 5 is an example of import data. The import data 23 includes a setting item to be set by the import processing and an import setting value associated with the setting item. The import data 23 includes “Minimum Password Length”, “Firmware Auto Recovery”, and “Server Port-HTTP” as setting items, and the respective setting values are “8”, “valid”, and “valid, 8080” in order.

In step S3, the setting value import controller 15d determines whether there is a setting item of the import data 23 among the setting items of the initial setup setting table 21. Since the setting items “Minimum Password Length”, “Firmware Auto Recovery”, and “Server Port-HTTP” of the import data 23 are all included in the initial setup setting table 21, the setting items “Minimum Password Length”, “Firmware Auto Recovery”, and “Server Port-HTTP” are extracted as the first extraction setting items, and step S5 is “YES”.

In step S7, the setting value import controller 15d compares the user setting value stored in the setting storage area 17f with the program setting value of the initial setup setting table 21 for each setting item of the first extraction setting item, and extracts the setting item in which both of the values match. In this case, since the user setting value is not changed after the execution of the initial setup wizard, the user setting value matches the program setting value. Therefore, here, the setting item of the first extraction setting item is extracted as the second extraction setting item as it is.

In step S11, the setting value import controller 15d compares the user setting value and the import setting value for each setting item of the second extraction setting items, and extracts the setting item in which the user setting value and the import setting value do not match as the third extraction setting item. The user setting values of the second extraction setting items “Minimum Password Length”, “Firmware Auto Recovery”, and “Server Port-HTTP” are “5”, “invalid”, “valid, 80”, respectively. On the other hand, the import setting values of “Minimum Password Length”, “Firmware Auto Recovery”, and “Server Port-HTTP” of the import data 23 are “8”, “valid”, “valid, 8080”, respectively. Therefore, since the three user setting values of the second extraction setting items are different from the three import setting values corresponding thereto, “Minimum Password Length”, “Firmware Auto Recovery”, and “Server Port-HTTP” are extracted as the third extraction setting items.

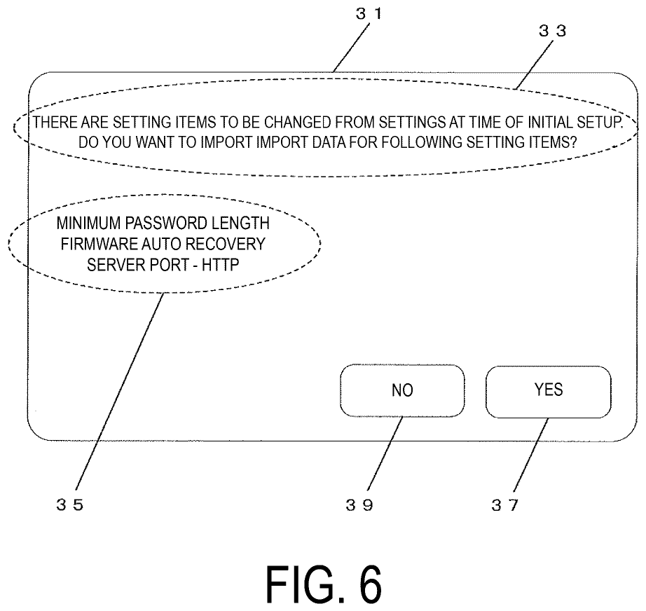

A confirmation screen 31 in FIG. 6 is an example of a confirmation screen displayed on the image forming apparatus according to the first embodiment of the present disclosure.

The confirmation screen 31 includes a text field 33, a setting item field 35, a YES button 37, and a NO button 39. The text field 33 is a field in which text indicating the content of an inquiry to the user is described. In the text field 33, the following messages are described: “THERE ARE SETTING ITEMS THAT WILL BE CHANGED FROM SETTINGS AT TIME OF INITIAL SETUP. DO YOU WANT TO IMPORT IMPORT DATA FOR FOLLOWING SETTING ITEMS?” The setting item field 35 is a field for displaying the third extraction setting item. Here, “Minimum Password Length”, “Firmware Auto Recovery”, and “Server Port-HTTP”, which are the third extraction setting items, are described.

In a case where an operation on the NO button 39 is received via the operation inputter 5 (step 17, NO), the setting value import controller 15d updates the user setting value of the corresponding setting item using the import setting value other than the third extraction setting item among the import setting values included in the import data 23 (step S19). Here, all the import setting values of the import data 23 correspond to the third extraction setting item. Therefore, there is no user setting value to be updated by the import processing based on the import data 23. That is, in a case where the operation to the NO button 39 is received via the operation inputter 5 (step S17, NO), the setting value import controller 15d executes the processing of step S19 in a case where the import setting value other than the third extraction setting item is included in the import setting values included in the import data 23, and does not execute the processing of step S19 in a case where the import setting value other than the third extraction setting item is not included in the import setting values included in the import data 23.

On the other hand, in a case where an operation to the YES button 37 is received via the operation inputter 5 (step 17, YES), the setting value import controller 15d updates the corresponding user setting value using all the import setting values included in the import data 23. That is, the controller 15 updates the corresponding user setting values using the import setting values of “Minimum Password Length”, “Firmware Auto Recovery”, and “Server Port-HTTP” included in the import data 23.

### [1.4 Summary]

According to the first embodiment, the user can designate whether to execute the import processing after collectively excluding the import setting values or to execute the import processing by applying the import data as it is, for the setting items extracted as the third extraction setting items (the setting items in which the setting values different from the setting values set in the initial setup wizard are set as the import setting values) in the import data, and thus the setting values intended by the user can be set.

### 2. Second Embodiment

Next, a second embodiment will be described. In the first embodiment, the user collectively designates whether to apply the import setting value of the third extraction setting item to the import processing. In contrast, in the second embodiment, the user individually designates whether to apply the import setting value for each setting item from among the setting items of the third extraction setting items. Only portions differing in configuration and processing from the first embodiment will be mainly described.

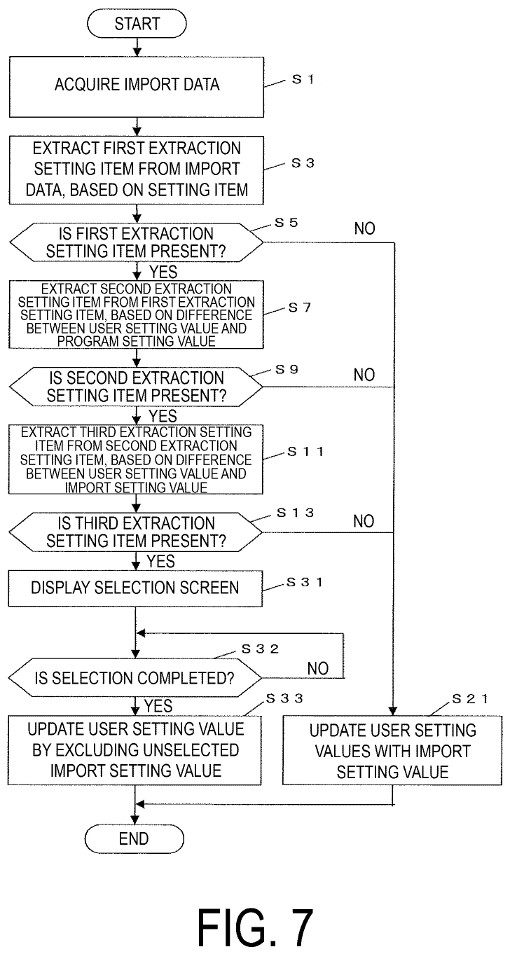

FIG. 7 is a flowchart illustrating an operation of an image forming apparatus according to a second embodiment of the present disclosure. In step S13, in a case where the third extraction setting item is present (step S13, YES), the display controller 15b displays a selection screen on the display 3 (step S31). The selection screen is a screen for selecting a setting item whose user setting value is to be updated with the import setting value from among the third extraction setting items. While the selection operation via the operation inputter 5 is not completed (step S32, NO), the display controller 15b displays the selection screen on the display 3, and when the selection operation is completed (step S32, YES), the display controller 15b closes the selection screen, and the setting value import controller 15d excludes the import setting value of the setting item that is not selected in step S32 from the import data, and updates the user setting value of the corresponding setting item using the remaining import setting value (step S33).

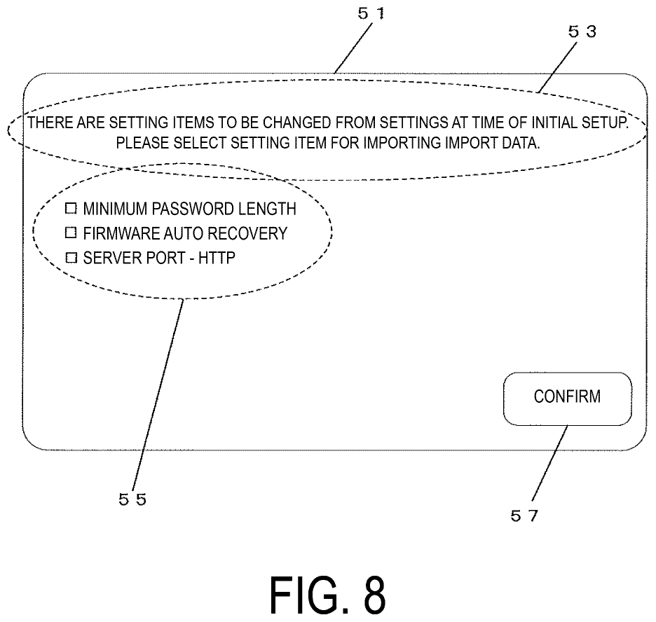

A selection screen 51 in FIG. 8 is an example of a selection screen displayed on the image forming apparatus according to the second embodiment of the present disclosure. The selection screen 51 includes a text field 53, a setting item field 55, and a confirmation button 57.

The text field 53 is a field in which text indicating the content of an inquiry to the user is described. In the text field 53, the following messages are described: “THERE ARE SETTING ITEMS THAT WILL BE CHANGED FROM SETTINGS AT TIME OF INITIAL SETUP. PLEASE SELECT SETTING ITEMS FOR WHICH IMPORT DATA IS TO BE IMPORTED”.

The setting item field 55 is a field for displaying the third extraction setting item and a checkbox for selecting a setting item. Here, “Minimum Password Length”, “Firmware Auto Recovery”, and “Server Port-HTTP”, which are the third extraction setting items, are described. Further, a checkbox is provided before each setting item. The user selects a desired setting item by performing an operation of checking a checkbox provided before the desired setting item using the operation inputter 5.

The confirmation button 57 is a button for confirming a selection operation to the checkbox, and after selection of a desired setting item is completed, the user operates the confirmation button 57 using the operation inputter 5, thereby confirming the setting item for which the checkbox is checked as a setting item to be updated with the import setting value. The confirmation button 57 can be operated even in a case where no setting item displayed in the setting item field 55 is selected, and in this case, the same processing as that in the case where the operation to the NO button 39 is received on the confirmation screen 31 of the first embodiment (step S17, NO) is performed.

According to the second embodiment, the user can designate the setting item to be the import processing target from among the setting items extracted as the third extraction setting items (the setting items in which the setting values different from the setting values set in the initial setup wizard are set as the import setting values) in the import data, and thus, the setting values intended by the user can be set.

### 3. Third Embodiment

A third embodiment will be described. In the third embodiment, a notification screen for notifying the user that the import processing is not executed for the setting item of the third extraction setting item is displayed. Only portions differing in configuration and processing from the first embodiment will be mainly described.

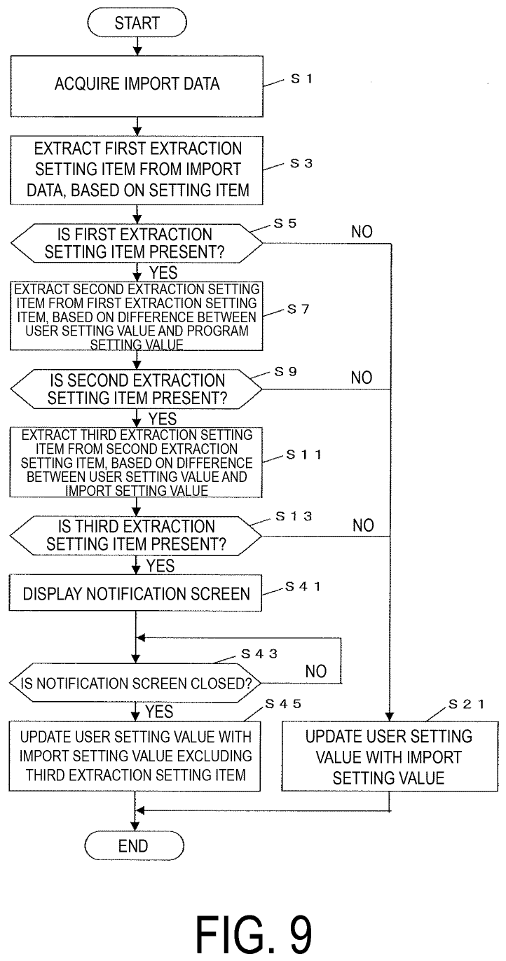

FIG. 9 is a flowchart illustrating an operation of an image forming apparatus according to the third embodiment of the present disclosure. In step S13, in a case where the third extraction setting item is present (step S13, YES), the display controller 15b displays a notification screen on the display 3 (step S41). The notification screen is a screen for notifying the user that the import processing is not performed on the setting item of the third extraction setting item. While an operation to close the notification screen via the operation inputter 5 is not received (step S43: NO) after a notification screen is displayed, the display controller 15b displays the notification screen on the display 3, and when the operation to close the notification screen is received (step S43: YES), the display controller 15b closes the notification screen, and the setting value import controller 15d excludes import setting values of third extraction setting items from the import data, and updates user setting values of corresponding setting items using the remaining import setting values (step S45).

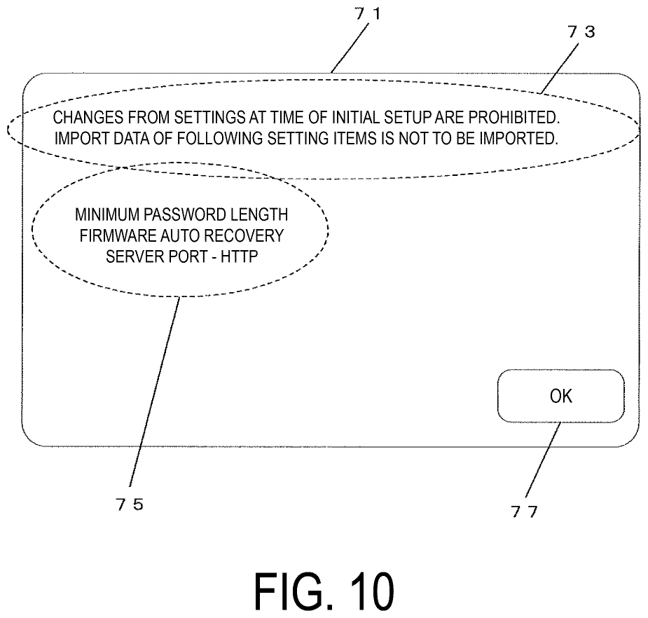

A notification screen 71 in FIG. 10 is an example of a notification screen displayed on the image forming apparatus according to the third embodiment of the present disclosure. The notification screen 71 includes a text field 73, a setting item field 75, and an OK button 77.

The text field 73 is a field in which text indicating the content of an inquiry to the user is described. In the text field 73, the following messages are described: “CHANGES FROM SETTINGS AT TIME OF INITIAL SETUP ARE PROHIBITED. IMPORT DATA OF FOLLOWING SETTING ITEMS WILL NOT BE IMPORTED”. The setting item field 75 is a field for displaying the setting item of the third extraction setting item, that is, the setting item that is not imported in the import processing. Here, “Minimum Password Length”, “Firmware Auto Recovery”, and “Server Port-HTTP”, which are the third extraction setting items, are described. The OK button 77 is a button operated by the user via the operation inputter 5 when the user confirms the contents of the text field 73 and the setting item field 75.

According to the third embodiment, it is possible to know that the change of the setting value set by the initial setup wizard is prohibited. Therefore, it is possible to know that the setting value of the setting item extracted as the third extraction setting item (the setting item in which the setting value different from the setting value set in the initial setup wizard is set as the import setting value) in the import data is not updated by the import processing.

### 4. Modification Example

The present disclosure is not limited to the embodiments and variations described above, and various variations are possible. In other words, the technical scope of the present disclosure also includes embodiments obtained by combining technical means that are appropriately modified within the scope of the gist of the present disclosure.

In the confirmation screen 31 and the selection screen 51, the third extraction setting items are displayed in the setting item fields 35 and 55; however, in addition to this, import setting values corresponding to the respective setting items may be displayed. In this case, the user can confirm the setting value in the case where the import setting value is applied. Although the initial setup wizard processing is described as an example of the process executed at the time of initial setup of the image forming apparatus 1, the process is not limited thereto, and the initial setup process may be executed in a format other than the wizard format.

The programs running on each device in the embodiments are programs for controlling a CPU or the like (programs for causing a computer to function) to implement the aforementioned functions in the embodiments. Information handled by these devices is temporarily accumulated in a temporary storage device (for example, a RAM) during processing, and is then stored in storage devices such as various read only memories (ROM), HDDs, and solid state drives (SSD), and is read, modified, and written by a CPU as necessary.

The recording medium storing the programs may be any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like. Further, not only are the functions of the above-described embodiments realized by executing the loaded program, but the functions of the present disclosure may also be realized by processing in cooperation with an operating system or another application program or the like, based on instructions from the program.

Further, when distributed in the market, the program can be stored in a portable recording medium and distributed, or can be transferred to a server computer connected via a network such as the Internet. In this case, it is obvious that a storage device of the server computer is also included in the present disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus, comprising:
a storage that stores one or more setting values corresponding to one or more setting items;
one or more controllers that execute control in accordance with the one or more setting values;
a display; and
an acquirer, wherein
the one or more controllers store one or more first setting values corresponding to one or more first setting items in the storage,
acquire one or more second setting values using the acquirer,
extract, from the one or more first setting items, one or more setting items in which the one or more first setting values different from the one or more second setting values are stored, and
display an update screen related to whether the one or more first setting values corresponding to one or more extracted setting items are updatable with the one or more second setting values on the display.

2. The image forming apparatus according to claim 1, wherein the one or more controllers display the update screen for inquiring whether a batch update of the one or more first setting values corresponding to the one or more extracted setting items with the one or more second setting values are executable on the display.

3. The image forming apparatus according to claim 1, wherein the one or more controllers display, on the display, the update screen for receiving a selection of one or more setting items, among the one or more first setting values corresponding to the one or more extracted setting items, for updating the one or more first setting values to the one or more second setting values.

4. The image forming apparatus according to claim 1, wherein the one or more controllers display, on the display, the update screen including a notification indicating that the one or more first setting values corresponding to the one or more extracted setting items are not to be updated to the one or more second setting values.

5. A control method of an image forming apparatus, the method comprising:
storing one or more first setting values corresponding to one or more first setting items;
acquiring one or more second setting values;
extracting, from the one or more first setting items, one or more setting items in which the one or more first setting values different from the one or more second setting values are stored; and
displaying an update screen related to whether the one or more first setting values corresponding to one or more extracted setting items are updatable with the one or more second setting values.
